(19) United States
(12) Patent Application Publication
(10) Pub. No.: US 2003/0118076 A1
(43) Pub. Date: Jun. 26, 2003

(54) Sensor for a contact-free temperature measurement

(75) Inventors: Jorg Schieferdecker, Schlangenbad (DE); Martin Hausner, Wiesbaden (DE); Wilhelm Leneke, Taunusstein (DE); Marion Simon, Bad Schwlabach (DE)

Correspondence Address: WOOD, HERRON & EVANS, LLP, 2700 CAREW TOWER, 441 VINE STREET, CINCINNATI, OH, 45202, US

(73) Assignee: PerkinElmer Optoelectronics GmbH

(21) Appl. No.: 10/238,546

(22) Filed: Sep. 10, 2002

(30) Foreign Application Priority Data
Sep. 10, 2001 (DE) 101 44 343.9

(51) Int. Cl. G01J 5/00

(52) U.S. Cl. 374/121

(57) ABSTRACT

A sensor for measuring a temperature by means of a heat-sensitive area applied onto and/or underneath a membrane, the membrane being arranged above a recess. The recess is etched by a reactive ion etching method such that it is fully defined laterally by side walls arranged at an angle between 80° and 100° relative to the membrane, adjoining side walls being arranged at an angle of at least 40° relative to one another.

### CROSS REFERENCE TO RELATED APPLICATIONS

This application claims priority under 35 U.S.C. §119 to German Patent Application No. 101 44 343.9 filed Sep. 10, 2001, the entirety of which is hereby incorporated herein by reference.

### FIELD OF THE INVENTION

The present invention relates to a sensor for measuring a temperature by means of a heat-sensitive area applied onto and/or underneath a membrane, the membrane being disposed above a recess.

### BACKGROUND OF THE INVENTION

A known temperature sensor is shown in FIG. 1. The sensor according to FIG. 1 has side walls arranged at an angle α relative to the bottom side of the sensor, i.e. the side opposite the membrane. The angle α of a known sensor according to FIG. 1 is approximately 54.7°.

Such sensors are known as thermal infrared sensors, or more particularly as thermopile sensors, the sensor being produced by means of micromechanics. In the sensor, a thin membrane produced of dielectric layers, e.g. SiO₂ or Si₃N₄ or the combination thereof, is located on the top side of a silicon substrate from which the sensor is made. The membrane is made by anisotropic etching, e.g. using KOH or EDP, wherein square membrane patterns may form in the silicon when the crystal orientation of the silicon chip is <100>. The walls of silicon etching follow what is called the 111 plane so as to form the typical walls inclined by about 54.7°. Corresponding sensors for temperature measurement are known from the following patent publications: EP 1 039 280 A2, EP 1 045 232 A2, EP 0 599 364 B1, U.S. Pat. Nos. 3,801,949, 5,693,942, DE 42 21 037 A1 and DE 197 10 946 A1, for example. Each of these patent publications is hereby incorporated herein by reference.

### SUMMARY OF THE INVENTION

It is the object of this invention to provide an improved sensor for temperature measurement and a corresponding process for the production thereof. In this connection, it is desired to design a corresponding sensor having the same sensitivity, if possible, with dimensions reduced as compared to the known sensors or to design a sensor having the same dimensions with increased sensitivity.

This object is achieved by a sensor for measuring a temperature by means of a heat-sensitive area applied onto and/or underneath a membrane located above a recess, the recess being etched by a reactive ion etching method. For this purpose, in particular deep reactive ion etching (DRIE) is advantageously used as the reactive ion etching method.

A sensor in accordance with the invention exhibits a sensitivity that is particularly high as compared to the dimensions thereof. A sensor in accordance with the invention having a sensitivity the same as that of a known sensor is markedly smaller.

The reactive ion etching method used in an advantageous embodiment of the invention yields a recess that is laterally fully defined by side walls. Adjoining side walls are arranged to each other at an angle of at least 40°, and at least one side wall (and in one embodiment, all of the side walls) are arranged at an angle between 80 and 100° relative to the membrane. Such a sensor has high sensitivity and has particularly small dimensions. Such a sensor also has a particularly narrow outer silicon edge and is suited, on its front side, for bonding pads and, on its rear side, for mechanical mounting on a housing base having an epoxide resin edge (typically 0.1 to 0.2 mm).

In a further advantageous embodiment of the invention adjoining side walls are arranged relative to one another at an angle of at least 45°, preferably at an angle of at least 80°.

In further emobidments, a passivation layer, e.g. made of Si₃N₄, can be applied to the heat-sensitive area.

A particularly small sensor is obtained by an embodiment of the invention in which adjoining side walls of the recess are arranged to one another at an angle of substantially 90°, e.g. 80° to 100°. Such a sensor has high sensitivity and has particularly small dimensions, since such a sensor which has the same sensitivity as a prior art sensor is about 0.5-0.7 mm smaller.

In an advantageous development in accordance with the invention, at least one side wall is arranged at an angle between 70° and 90°, in particular at an angle between 85° and 90°, relative to the membrane such that the membrane area defining the recess is larger than an open (or, where appropriate, closed) area opposite the membrane. In this connection, all of the side walls are advantageously arranged at an angle between 70° and 90°, in particular at an angle between 85° and 90°, relative to the membrane so that the membrane area defining the recess is larger than an open (or, where appropriate, closed) area opposite the membrane. Such a sensor has special mechanical stability without a loss of sensitivity.

In a further advantageous development in accordance with the invention, all of the side walls are substantially made of silicon.

In a further advantageous development in accordance with the invention, the sensor is a thermopile, the heat-sensitive area including a series connection of at least two thermoelectric materials, in particular materials made respectively of p-conducting silicon and aluminum or n-conducting silicon and aluminum or p-conducting silicon and n-conducting silicon. The thermoelectric material may be crystalline or polycrystalline silicon, polysilicon germanium or amorphous silicon. It is particularly advantageous for the series connection to include adjoining areas of p-conducting silicon and n-conducting silicon, which are joined with each other via a metal beam, in particular aluminum (advantageously having two contact windows). The adjoining areas of p-conducting silicon and n-conducting silicon increase the signal voltage of the sensor by 30 to 80% as compared to an embodiment comprising n-conducting polysilicon and aluminum.

In a further advantageous development in accordance with invention in which the sensor is a thermopile, the series connection has at least one p-conducting silicon layer and at least one n-conducting silicon layer, which are arranged on top of one another and are separated by an insulating layer, in particular by silicon oxide or silicon nitride. In this way, the signal voltage of the sensor can be increased by another 10 to 15%.

In a further advantageous development in accordance with the invention, the sensor is a pyroelectric sensor, the heat-sensitive area including a stack of two electrode layers and a pyroelectric layer located between the two electrode layers, in particular a thin pyroelectric layer, e.g. poyroelectric ceramics or polymer layers, which are deposited on the lower electrode layer in particular by sputtering, spinning or CVD process.

In a further advantageous development in accordance with the invention, the sensor is a bolometer, the heat-sensitive area including a meander layer made of a metal oxide or a semiconductor, in particular having a very high temperature coefficient, i.e. especially a temperature coefficient of at least 2 10⁻³ K⁻¹, preferably 2 10⁻² K⁻¹, of the resistance.

In a further advantageous development in accordance with the invention, the membrane is rectangular, advantageously square. In a further advantageous development, the corners of the membrane have recesses so as to form a cruciform base. It is advantageous to provide bonding pads within these recesses.

In a further advantageous in accordance with the invention, the sensor is integrated into a semiconductor chip, in particular a silicon chip.

According to the method of producing a temperature measurement sensor in accordance with the invention, a membrane is favorably applied to a support, advantageously a silicon support, and a recess is etched into the support underneath the membrane by a reactive ion etching method. Deep reactive ion etching (DRIE) is used in a very advantageous manner as the reactive ion etching method.

For the production of the almost vertical side walls of the etching pits in the silicon it is favorable to use what is called an ICP reactor (inductively coupled plasma) in which (unlike reactive ion etching reactor) additional energy is supplied to the plasma via inductive coupling. This results in extremely dense ionization and enables high etch rates of several μm silicon per minute.

(Isotropic) etching is performed using fluorine radicals (e.g. SF6 as an etching gas), an etch phase rhythmically alternating with what is called a passivation phase, on the surface of the side walls (of the etch pits) of which a polymer layer is deposited (e.g. by adding C4F8) which prevents laterally pointed etching. At the pit bottoms, the formation of polymer is prevented by applying a BIAS voltage. This process is disclosed in more detail in U.S. Pat. No. 5,501,893, for example.

Surprisingly, the above-described process (hereinafter also referred to as process) can be used for the following applications:

what is called “through the wafer etching”: Contrary to common processes having an etching depth of some ten μm, etching is carried out through the wafer (etching depth about 200 to 800 μm)

The area exposed to the plasma during the etching step is about 20% to 50% of the entire wafer surface. (In conventional processes, the area etched only covers some % of the entire surface.) In order to ensure sufficient homogeneity of the etching depth throughout the entire wafer, the process has to be controlled with a selectivity minor with respect to the mask material. This in turn calls for the use of an extremely resistant mask material.

It is possible to influence certain properties of the sensor element by a suitable process control:

Due to the passivation cycle reduction the etching process is somewhat less anisotropic and no model vertical walls are obtained but the etching pit widens downwardly. This etching profile is referred to as “reentrant”. This is advantageous above all for multi-unit sensors in which a thin partition wall of several μm separates one etch pit from the adjacent one. The walls on the rear side of the wafer are thinner than those on the membrane side, which increases stability.

In order not to damage the dielectric membrane when it is struck, and to still ensure a good structural transfer and a clean membrane surface, the entire process should comprise several steps fundamentally differing as regards the selection of the process parameters. A first step with good homogeneity and (advantageously) high etching rate is followed, as soon as the membrane is reached, by a step having very high selectivity with respect to the membrane material, i.e. a minor etching rate as regards silicon oxide. A subsequent purely isotropic step (i.e. without passivation cycles) finally removes possible silicon residues on the membrane.

In order to clean the membrane, it is also possible to use short wet chemical etching in TMAHW (tetraammonium hydroxide in water), the front side of the wafer being protected by suitable methods, e.g. masked by photoresist.

In an advantageous development of the process in accordance with the invention, a layer having a low etching rate for the reactive ion etching method is applied to a support side facing away from the membrane before the recess is etched. Such a layer is advantageously a layer patterned photolithographically, e.g. a layer made of thick photoresist, a silicon oxide layer or a metal layer.

In a further advantageous development of this process, a heat-sensitive area is applied to the membrane.

The above and other objects and advantages of the present invention shall be made apparent from the accompanying drawings and the description thereof.

### BRIEF DESCRIPTION OF THE DRAWING

Further advantageous embodiments follow from the subclaims and from the below description of embodiments, in which

FIG. 1 shows a known sensor for temperature measurement;

FIG. 2 shows an embodiment of a temperature sensor according to the invention;

FIG. 3 shows another embodiment of a temperature sensor according to the invention;

FIG. 4 shows the use of a temperature sensor according to the invention in a temperature measuring system;

FIG. 5 shows the use of a temperature sensor according to the invention in a temperature measuring system;

FIG. 6 shows a chip body;

FIG. 7 shows a particularly advantageous development of a chip body;

FIG. 8 shows a top view of a temperature sensor designed as a thermopile;

FIG. 9 shows a side view of another temperature sensor designed as a thermopile;

FIG. 10 shows a particularly advantageous development of a temperature sensor designed as a thermopile;

FIG. 11 shows a side view of a temperature sensor designed as a pyroelectric sensor;

FIG. 12 shows a chip having several sensors; and

FIG. 13 shows, in principle, a process for producing a sensor.

The accompanying drawings, which are incorporated in and constitute a part of this specification, illustrate embodiments of the invention and, together with a general description of the invention given above, and the detailed description of the embodiments given below, serve to explain the principles of the invention.

### DETAILED DESCRIPTION OF SPECIFIC EMBODIMENTS

FIG. 1 shows a known sensor 1 for temperature measurement. It has a silicon body 2 including a recess 8. A membrane 3 is located above the recess. A heat-sensitive area 4 is applied to the membrane. Recess 8 is defined by side walls 5 arranged at an angle” of about 54.7° with respect to the plane of the bottom side 6 of chip body 2, i.e. the side opposite membrane 3 with respect to recess 8.

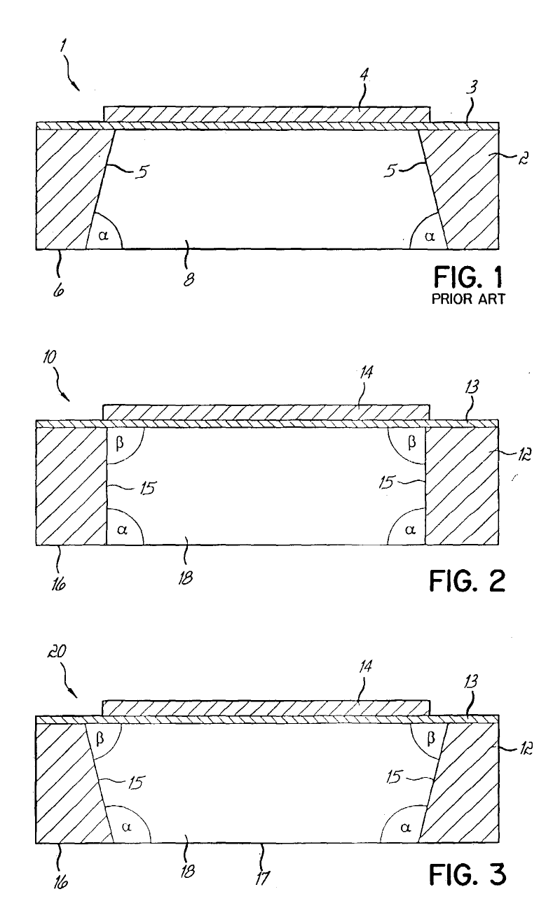

FIG. 2 shows an embodiment for a sensor 10 according to the invention for temperature measurement. It includes a chip body 12 having a recess 18. Recess 18 is laterally defined by side walls 15. A membrane 13 is located above recess 18. Again, a heat-sensitive area 14 is arranged on membrane 13. In a particularly advantageous development this area is sensitive to infrared. Side walls 15 of recess 18 are aligned at an angle α with respect to the plane of the bottom side 16 of chip body 12. Angle α is advantageously 80 to 100°. With respect to the plane of membrane 13, the side walls 15 are arranged at an angle β of accordingly 100 to 80°.

FIG. 3 shows a sensor 30 for temperature measurement, which is advantageous as compared to temperature sensor 10 in FIG. 2. In this case, equal parts have reference numerals the same as those in FIG. 2. The side walls 15 of recess 18 of sensor 30 are arranged relative to membrane 13 such that angle 13 is between 80 and 89°. In this way, considering bottom side 16 of chip body 12, the area 17 opposite membrane 13 is smaller than the area, defining recess 18, of membrane 13. At a negligible loss of sensitivity, a particularly stable chip body 12 having small outer dimensions is obtained in this way.

Membrane 13 of sensors 10 and 20 in FIG. 2 and FIG. 3 advantageously consists of dielectric layers, e.g. SiO₂ or Si₃N₄ SiC or a combination thereof. The membrane is created by reactive dry etching (what is called DRIE).

When the sensors 10 and 20 are developed as thermopiles, the heat-sensitive area 14 includes a series connection of at least two thermoelectric materials, such as n-conducting polysilicon and aluminum, p-conducting polysilicon and aluminum or advantageously n-conducting and p-conducting silicon. When the sensor 10 and/or sensor 20 is developed as a pyroelectric sensor, the heat-sensitive area 14 includes a thin pyroelectric layer between a metallic back electrode and a roof electrode. When sensor 10 and/or sensor 20 is developed as a bolometer, the heat-sensitive area 14 has a metal oxide or semiconductor meander layer.

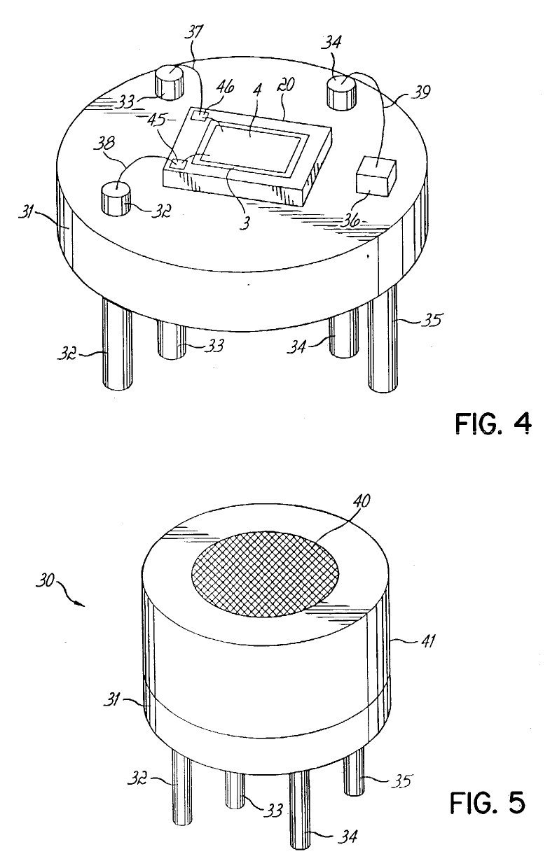

FIG. 4 and FIG. 5 show the advantageous use of a sensor 20 in a temperature measuring system. It is also possible to use sensor 10 instead of sensor 20. According to the embodiment in FIG. 4, sensor 20 is placed, in particular centrically, on abase plate 31. Base plate 31 is e.g. a transistor base plate TO-5 or TO-18. It is advantageous to bond chip 20 onto base plate 31 by means of an epoxide resin adhesive with good thermal conductivity.

Contacts 32, 33 and 34 pass through base plate 31. Contacts 32 and 33 are connected to what is called bonding pads 45 and 46 on sensor 20 via conducting connections 38 and 37.

For measuring the temperature of temperature measuring system 30, it is advantageous to dispose an additional temperature sensor 36 on base plate 31. This sensor is connected to contact 34 through a conductor 39.

As shown in FIG. 5, a casing 41 is disposed on the base plate, which surrounds a sensor 20. Casing 41 has an infrared filter 40. Casing 41 is advantageously designed as a transistor cap.

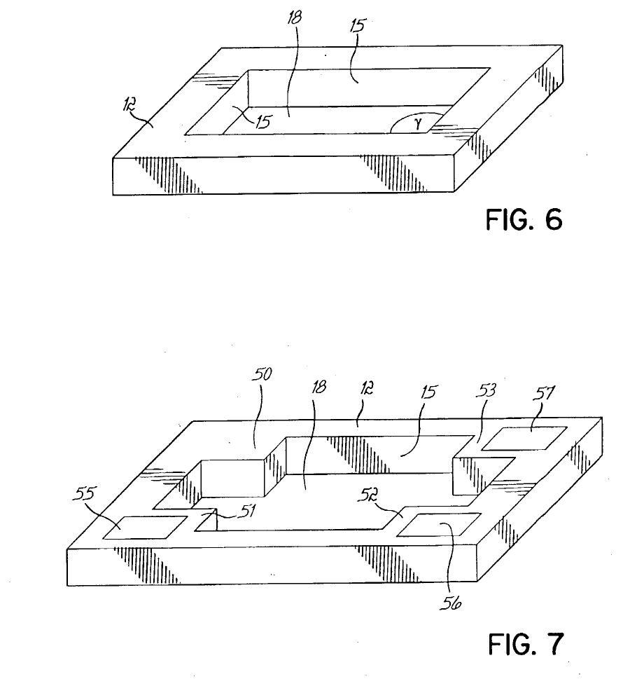

FIG. 6 shows the design of chip body 12. Reference numeral 18 stands for the recess and reference numeral 15 designates the side walls. The side walls are advantageously arranged approximately at right angles to each other, i.e. the angle referred to by reference sign α is approximately 90°.

FIG. 7 shows a particularly advantageous development of chip body 12. Here, recess 18 has a cruciform base area so that chip body 12 defines recess 18 by solid corners 50, 51, 52 and 53. Bonding pads 55, 56 and 57 are provided for in corners 51, 52 and 53.

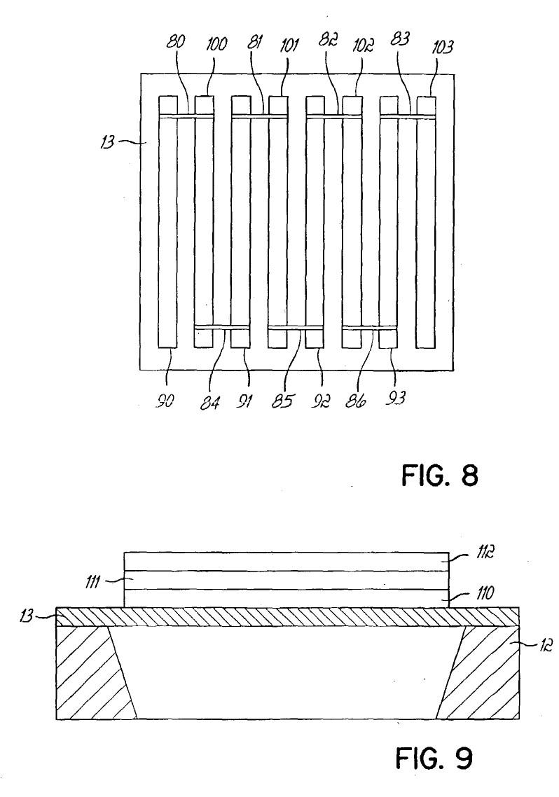

FIG. 8 shows a top view onto a temperature sensor designed as a thermopile. Strips 90, 91, 92, 93 of p-conducting silicon, p-conducting polycrystalline silicon or p-conducting polycrystalline silicon-germanium and strips 100, 101, 102, 103 of n-conducting silicon, n-conducting polycrystalline silicon or n-conducting polycrystalline silicon-germanium are arranged on membrane 13. The individual strips 90, 91, 92, 93, 100, 101, 102, 103 are joined with one another to form an electric series connection through beams 80, 81, 82, 83, 84, 85, 86. FIG. 8 shows a configuration having eight beams. Twenty to two hundred beams, preferably sixty to one hundred and twenty beams, are advantageously arranged on membrane 13. Alternative embodiments of beams 80, 81, 82, 83, 84, 85, 86 are, of course, possible to obtain a series connection of strips 90, 91, 92, 93, 100, 101, 102, 103.

FIG. 9 shows a side view of an alternative temperature sensor designed as a thermopile. Here, the heat-sensitive area arranged on membrane 13 comprises two layers 110 and 112 of thermoelectric material separated by an insulating layer 111, e.g. of silicon nitride or silicon oxide. Layer 110 is here made of n-conducting or p-conducting silicon, n-conducting or p-conducting polycrystalline silicon or n-conducting or p-conducting polycrystalline silicon-germanium. Layer 112 consists of p-conducting or n-conducting silicon, p-conducting or n-conducting polycrystalline silicon or p-conducting or n-conducting polycrystalline silicon-germanium. Both layers are series connected by means of a contact window (not shown). In an advantageous embodiment, two or three arrangements separated from one another by further insulating layers are provided in accordance with the arrangement of layers 110, 111 and 112.

It is particularly advantageous for the n-conducting and p-conducting layers to be arranged both on top of one another and side by side, the individual layers being series connected. A simplified example of such a layer is shown in FIG. 10. Here, reference numerals 120, 124, 132 and 136 designate layers or strips of n-conducting silicon, n-conducting polycrystalline silicon or n-conducting polycrystalline silicon-germanium. Reference numerals 122, 126, 130 and 134 stand for layers or strips of p-conducting silicon, p-conducting polycrystalline silicon or p-conducting polycrystalline silicon-germanium. Reference numerals 121, 123, 125, 131, 133, 135 designate insulating layers. Layers 120 and 122, 122 and 124, 124 and 126, 130 and 132, 132 and 134 as well as 134 and 136 are electrically connected with one another via contact windows. Layers 126 and 136 are electrically connected with each other through an aluminum beam 139, so that layers 120, 122, 124, 126, 136, 134, 132 and 130 are series-connected. In this connection, it is advantageously intended to provide according to FIG. 8 more than two stacks of layers 120 to 126 and 130 to 136.

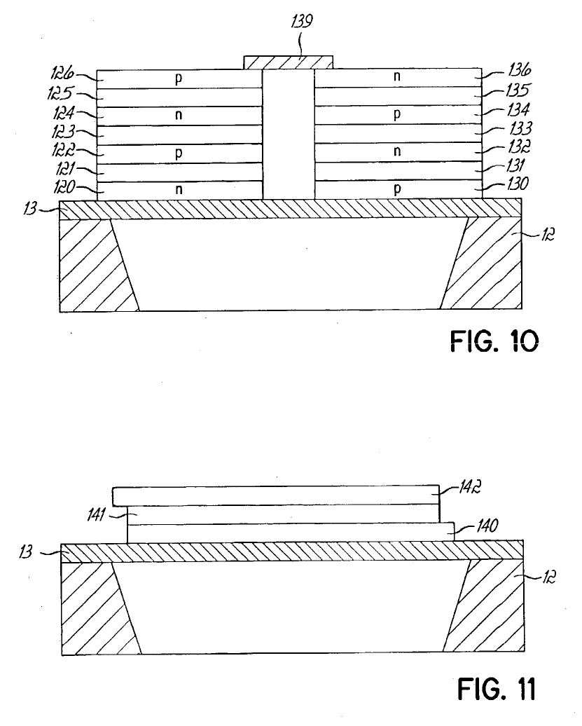

FIG. 11 shows a side view of an embodiment for a temperature sensor designed as a pyroelectric sensor. Here, the heat-sensitive area applied to membrane 13 is a bottom electrode 140 and a top electrode 142 as well as a pyroelectric layer disposed between bottom electrode 140 and top electrode 142.

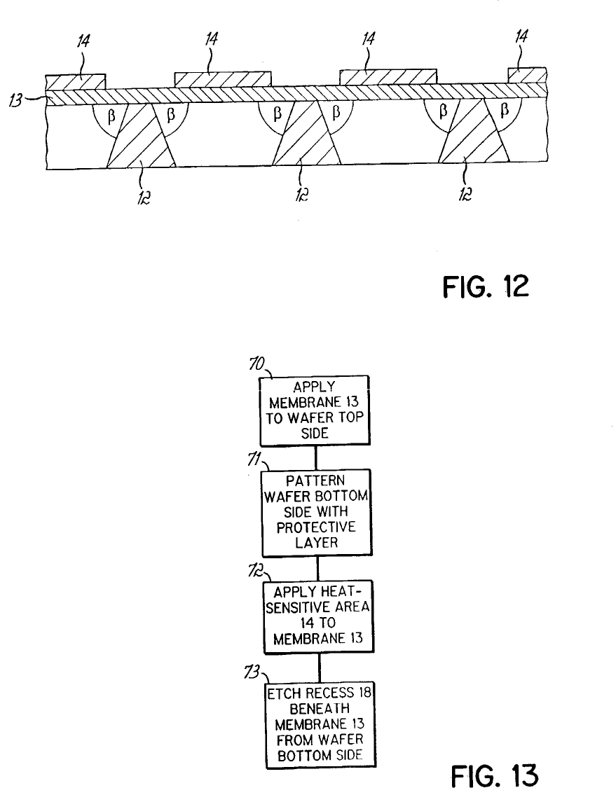

The sensors according to the invention can be arranged separately on a chip or several of them can be arranged jointly thereon. The latter is shown in FIG. 12. FIG. 12 shows a chip 200 comprising several sensors 20 according to FIG. 3.

FIG. 13 shows, in principle, a method of producing a sensor 10 and 20. Here, in a first step 70, membrane 13 is initially applied to a top side of a wafer which in the finished state of the sensor forms silicon body 12.

In a next step 71, a protective layer having a minor etching rate for the reactive ion etching method is applied to a bottom side 16 of the wafer, facing away from the membrane, i.e. with reference to the above-mentioned embodiments side 16 of silicon body 12. Such a layer is advantageously a layer which can be patterned photolithographically (see above).

In another step 72, a heat-sensitive area 14 is applied to membrane 13.

In another step 73, a recess is subsequently etched into the wafer underneath the membrane by an above explained reactive ion etching method.

Step 73 may also precede step 72.

In a particularly advantageous way, in all of the developments of the sensors the heat-sensitive area is covered by an infrared-absorbing layer (not shown in the figures) which can be patterned photolithographically (see claim 24). This layer is advantageously a photoresist having absorber particles, as disclosed in particular in German Patent Application DE 4221037 A1 “Thermal sensor having an absorber layer”, which is incorporated herein by reference.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A sensor for measuring a temperature by means of a heat-sensitive area applied onto and/or underneath a membrane, the membrane being arranged above a recess fully defined laterally by side walls,
at least one side wall being arranged at an angle between 80° and 100° relative to the membrane.

2. A sensor for measuring a temperature by means of a heat-sensitive area applied onto and/or underneath a membrane, the membrane being arranged above a recess, wherein the recess is etched by a reactive ion etching method.

3. The sensor of claim 1 or 2, wherein the recess is defined laterally by side walls, adjoining side walls being arranged at an angle of at least 40° relative to one another.

4. The sensor of claim 2, wherein at least one side wall is arranged at an angle between 80° and 100 ° relative to the membrane.

5. The sensor of claim 2, wherein the recess is defined laterally by at least one side wall disposed at an angle between 80° and 100° relative to the membrane.

6. The sensor of one of claims 1 or 2, wherein adjoining side walls are arranged at an angle of at least 80° relative to one another.

7. The sensor of claim 6, wherein adjoining side walls are arranged at an angle of substantially 90° relative to one another.

8. The sensor of claim 6, wherein at least one side wall is arranged at an angle between 80° and 90° relative to the membrane.

9. The sensor of one of claims 1 or 2, wherein all the side walls of the recess consist substantially of silicon.

10. The sensor of one of claims 1 or 2, wherein that the heat-sensitive area has a series connection comprising at least two thermoelectric materials.

11. The sensor of claim 10, wherein the two thermoelectric materials are respectively p-conducting silicon and aluminum or n-conducting silicon and aluminum or p-conducting silicon and n-conducting silicon.

12. The sensor of claim 10, wherein the series connection includes p-conducting silicon and n-conducting silicon arranged side by side.

13. The sensor of claim 10, wherein the series connection has at least one p-conducting silicon layer and at least one n-conducting silicon layer, which are superposed and separated by an insulating layer.

14. The sensor of one of claims 1 or 2, wherein that the heat-sensitive area has a stack of two electrode layers and a pyroelectric layer arranged between said two electrode layers.

15. The sensor of one of claims 1 or 2 wherein the heat-sensitive area is a meander layer of a metal oxide or a semiconductor.

16. The sensor of one of claims 1 or 2, wherein the membrane is rectangular.

17. The sensor of claim 16, wherein the recess has a cruciform base.

18. A silicon semiconductor chip comprising the sensor of one of claims 1 or 2.

19. The sensor of one of claims 1 or 2, wherein the heat-sensitive area comprises a series connection of at least two thermoelectric materials, the two thermoelectric materials being respectively p-conducting silicon, polycrystalline silicon or polycrystalline silicon-germanium and n-conducting silicon, polycrystalline silicon or polycrystalline silicon-germanium.

20. The sensor of claim 19, wherein the series connection includes, arranged side by side, p-conducting silicon, polycrystalline silicon or polycrystalline silicon-germanium and n-conducting silicon, polycrystalline silicon or polycrystalline silicon-germanium.

21. The sensor of claim 19, wherein the series connection has 20 to 200, preferably 60 to 120, layers arranged side by side, in particular in pairs, of p-conducting silicon, polycrystalline silicon or polycrystalline silicon-germanium and n-conducting silicon, polycrystalline silicon or polycrystalline silicon-germanium.

22. The sensor of claim 20, wherein the series connection has at least one p-conducting silicon layer, polycrystalline silicon layer of polycrystalline silicon-germanium layer and at least one n-conducting silicon layer, polycrystalline silicon layer or poly crystalline silicon-germanium layer, which are superposed and separated by an insulating layer.

23. The sensor of claim 22, wherein the series connection has two or three layer pairs of p-conducting silicon, polycrystalline silicon or polycrystalline silicon-germanium and n-conducting silicon, polycrystalline silicon or polycrystalline silicon-germanium, which are superposed and separated by an insulating layer.

24. The sensor of claim 1 or 2, or the semiconductor chip of claim 18, further comprising an infrared-absorbing layer which can be patterned photoelectrically, applied to the temperature-sensitive area.

25. A process for producing a sensor for temperature measurement, comprising
providing a membrane applied to a support, and
etching a recess into the support underneath the membrane using a reactive ion etching method.

26. The process of claim 25, wherein, prior to etching the recess, a layer having a minor etching rate for the reactive ion etching method is applied to a support side facing away from the membrane.

27. The process of claim 25, wherein a heat-sensitive area is applied to the membrane.

28. A process for producing a sensor for temperature measurement, comprising,
in an activation phase etching a recess having side walls into a support by means of a reactive ion etching method,
in a passivation phase, depositing a protective layer, in particular a polymer layer, on the side walls, which protective layer prevents or markedly reduces removal of material from the side walls, and
alternating additional activation phases and passivation phases, the passivation phases being moderated and/or reduced, and/or the activation phases being intensified and/or extended.

29. The process of claim 28, wherein the passivation phases are moderated and/or reduced and/or the activation phases are intensified and/or extended such that the side walls are at an angle between 80° and 90° relative to the support surface.

30. The process of claim 29, wherein the passivation phases are moderated and/or reduced and/or that the activation phases are intensified and/or extended such that the side walls are at an angle between 85° and 90° relative to the support surface.

31. The process of claim 25, wherein the support is a silicon body.
